(19) United States
(12) Patent Application Publication
(10) Pub. No.: US 2025/0085567 A1
(43) Pub. Date: Mar. 13, 2025

(54) ENGAGING AND SECURING STRUCTURE OF FLIP-UP EYEGLASSES

(71) Applicant: OURAD SAFETY CO., LTD., TAINAN CITY (TW)

(72) Inventor: PIN-TSUNG HUANG, TAINAN CITY (TW)

(21) Appl. No.: 18/463,395

(22) Filed: Sep. 8, 2023

(51) Int. Cl. G02C 5/04; G02C 9/04

(52) U.S. Cl. CPC G02C 5/04; G02C 9/04

(57) ABSTRACT

An engaging and securing structure of flip-up eyeglasses includes a first lens and a second lens. The first lens is provided with an engaging portion. The engaging portion is provided therein with a first engaging groove and a second engaging groove. The second lens is provided with an engaging block. The engaging block has a non-circular cross section and peripherally forms a plurality of corners that correspond to the first engaging groove or the second engaging groove and are defined as engaging corners. Any of the engaging corners can be selected to be engaged in the first engaging groove or the second engaging groove. The first lens and the second lens are made of plastic and are held together without using metal screws or elastic elements, thereby preventing occupational safety accidents attributable to electrical conduction through such metal screws or elastic elements.

### BACKGROUND OF THE INVENTION

### 1. Technical Field

The present invention relates to an eyeglass structure in which a second lens can be secured at any selected one of a plurality of angular positions with respect to a first lens.

### 2. Description of Related Art

3C products (i.e., computers, communication devices, and consumer electronics) abound in our daily lives, but using those products, in particular watching the contents displayed on their screens, over an extended period of time tends to impair eyesight or even cause damage to the eyes. This may explain why more and more people wear eyeglasses for vision correction. Besides, one who is performing a medical procedure, carrying out a soldering or grinding operation, doing sports, taking part in a racing competition, or simply feeling the need to shield their eyes from the sun may wear a pair of eyeglasses (or goggles) to protect their eyes from injury. If they wear eyeglasses in the first place, they would have to choose goggles with a relatively large accommodating space for accommodating eyeglasses with different common eyeglass frames, so they can wear the goggles as well as their eyeglasses during work or other activities. Furthermore, the pivotal connection elements used for the flip-up lens of a pair of flip-up eyeglasses (or goggles) are generally metal screws or elastic elements. Such metal screws or elastic elements nevertheless require a complicated and time-consuming locking operation and have a relatively great weight that makes it impossible to reduce the weight of the eyeglasses (or goggles). Moreover, such metal screws or elastic elements are likely to conduct electricity and may therefore raise occupational safety concerns, posing a danger to those wearing eyeglasses (or goggles) during work.

In view of this, Taiwan Utility Model U.S. Pat. No. 416,303, published on Dec. 21, 2000, and entitled “GOGGLES,” discloses a pair of goggles that includes an eye-covering member and a lens holder. The eye-covering member has a front frame whose front-end top side is provided with two engaging bases that protrude upward. Each of the two engaging bases has two lateral sides each provided with a laterally protruding engaging rod, and an upwardly extending separation plate is provided between the two engaging bases. The lens holder has a top end provided with two grooves each corresponding to one of the two engaging bases. Each groove has two lateral portions configured as a notch portion and a hole portion. A slide groove is provided between the two grooves and is in the hole-portion side of one of the grooves. The lens holder is further provided with a recess and a forwardly extending inclined groove, both corresponding to the separation plate. Each of the two grooves of the lens holder can receive the corresponding one of the two engaging bases, and the separation plate can slide into the recess through the slide groove and be engaged in the recess such that the lens holder is pivotally engaged with an upper part of the eye-covering member. This goggle structure can be easily assembled, is suitable for use in oxy-fuel welding and cutting, and has industrial applicability.

While the eye-covering member and the lens holder in the '303 patent are pivotally coupled to form a structure that allows the lens holder to be flipped up, the lens holder cannot be held at multiple angular positions with respect to the eye-covering member. This is a deficiency of the flip-up function of the patented goggles in use.

As a solution, Taiwan Utility Model Patent No. M479433, published on Jun. 1, 2014, and entitled “EYEGLASS STRUCTURE ALLOWING LENSES TO BE FLIPPED OPEN AND CLOSED,” discloses a primary eyeglass frame mounted with main-function lenses and a secondary eyeglass frame mounted with second-function lenses and connected to the primary eyeglass frame by a connecting member. The secondary eyeglass frame is gripped by one end of the connecting member. An abutting portion extends from a predetermined portion of the connecting member and is inserted into a space under the rotating rod of the secondary eyeglass frame such that a lower end of the connecting member is fitted into a corresponding space in the primary eyeglass frame. The secondary eyeglass frame, which is connected to the upper end of the primary eyeglass frame, can be rotated downward for use and flipped up when not in use, and only a simple operation is required to secure the secondary eyeglass frame at a number of angular positions.

In the '433 patent, the flipping and positioning of the secondary eyeglass frame with respect to the primary eyeglass frame is achieved by rotating the rotating rod of the secondary eyeglass frame and thus bringing any of the peripheral sides of the rotating rod (which has a non-circular cross section) into stable contact with the abutting portion of the connecting member. As the non-circular cross section of the rotating rod is a quadrilateral, multi-stage positioning of the secondary eyeglass frame is limited to such angular positions at 90° and 180° only; in other words, the number of available options of angular positions is relatively small. Furthermore, the engaging and securing mechanism between the secondary eyeglass frame and the primary eyeglass frame provides ease of disassembly and reassembly at the expense of an anti-separation design. The secondary eyeglass frame may separate from the primary eyeglass frame after the eyeglasses have been used for some time, and this leaves much to be desired in terms of use.

### BRIEF SUMMARY OF THE INVENTION

In view of the foregoing drawbacks of the conventional engaging and securing structures of flip-up eyeglasses, the present invention provides another such structure, which includes a first lens and a second lens. The first lens is provided with a first pivotal connection portion. The first pivotal connection portion has two lateral sides each provided with a pivot block. The two pivot blocks face each other and are each formed with a pivot hole. The two pivot holes face each other. An engaging portion is provided between the two pivot blocks, and the engaging portion is provided therein with a first engaging groove and a second engaging groove that are adjacent to each other and in a front-and-rear relationship. The second lens is provided with a second pivotal connection portion. The second pivotal connection portion is pivotally connected to the first pivotal connection portion, and the second pivotal connection portion has two lateral sides each provided with a pivot shaft. Each pivot shaft corresponds to and is engaged in one of the two pivot holes. The second pivotal connection portion is further provided with an engaging block between the two pivot shafts, and the engaging block corresponds in position to the engaging portion. The engaging block has a non-circular cross section and forms a plurality of contact surfaces with respect to the engaging portion. The corner formed between each two adjacent contact surfaces is defined as an engaging corner. Any of the contact surfaces can be selected to lie flat on the engaging portion, or any of the engaging corners can be selected to be engaged in the first engaging groove or the second engaging groove, such that the second lens can be secured at a plurality of angular positions with respect to the first lens.

The first lens has an eyeglass frame portion, and the first pivotal connection portion is located at a middle portion of the eyeglass frame portion. The second pivotal connection portion is located at a middle portion of the second lens.

One of the pivot blocks is provided with a notch adjacent to and in communication with the corresponding pivot hole. One of the pivot shafts has an end portion corresponding to the notch and cut flat on two opposite sides to form an engaging end. The engaging end of this pivot shaft can be passed through the notch and then engaged in the corresponding pivot hole.

The engaging end has a thickness smaller than the size of the opening of the notch.

The engaging block has a quadrilateral cross section, the engaging block has four contact surfaces with respect to the engaging portion, and the periphery of the engaging block forms four engaging corners corresponding to the first engaging groove or the second engaging groove.

The first lens, the first pivotal connection portion, the second lens, and the second pivotal connection portion are made of plastic and are put together by engagement between corresponding structures, so there is no need to use metal screws or elastic elements to hold the lenses and pivotal connection portions together.

The second lens may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity.

The first lens has two ends each pivotally connected with a temple.

The first lens has two lateral sides (i.e., a left side and a right side) each extended with a transparent lateral window portion.

Each lateral window portion is detachably coupled with a soft sealing pad along a lateral side and a bottom portion of the lateral window portion.

The foregoing technical features have the following advantages:

1. The plurality of engaging corners can be selectively brought into engagement in the first engaging groove or the second engaging groove to define a plurality of angular positions at which the second lens can be secured. Therefore, depending on the vision requirements of work or other activities, the user of a pair of eyeglasses using the engaging and securing structure of the present invention (hereinafter referred to as the eyeglasses) can flip the second lens to any selected one of the defined angular positions by rotating and positioning the second lens with respect to the first lens in multiple stages.

2. The second lens can be chosen from a range of lenses that have different functions, in order to suit different work environments or activity environments. For example, the second lens may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity. In short, the second lens can be selected from a diversity of functional lenses.

3. The second lens can be easily detached in its entirety from the first lens by pulling the engaging end out of the corresponding pivot hole through the notch, and a new or different second lens can be easily connected to the first lens by pushing the engaging end into the corresponding pivot hole through the notch. As the second lens will not separate from the first lens easily, the work or activity the eyeglass user is doing will not be hindered by such separation, nor will there be occupational safety hazards attributable to such separation.

4. As the first lens and the second lens are both made of plastic and are put together by engagement between corresponding male and female engaging structures, there is no need to hold the first lens and the second lens together with metal screws or elastic elements. This allows the weight of the eyeglasses to be reduced in comparison with their prior art counterparts so that a lightweight design can be attained.

5. Since no metal screws or elastic elements are required to hold the lenses together, electrical hazards associated with the use of metal screws or elastic elements do not exist when someone wears the eyeglasses during work or other activities. The present invention, therefore, ensures the safety of a user of the eyeglasses by reducing occupational safety accidents that may result from inadvertent electrical conduction through such metal screws or elastic elements.

6. The second lens is a movable and detachable structure and is therefore suitable for being secured to any first lens regardless of whether the first lens is mounted in an eyeglass frame or is a frameless lens. The second lens can be detached and put back in place with ease, has wide applicability, and is not subject to limitations imposed by the structures of different first lenses (which may be mounted in an eyeglass frame or be a frameless lens).

7. The soft sealing pads are configured to be in close contact with those areas of the user's face that are on the outer lateral sides of, and below, the user's eyes in order to keep foreign objects from flying into the eyeglasses while the user is working, or prevent a patient's body fluid, bacteria, or virus from reaching the user's eyes through a gap between the eyeglasses and the user's face while the user is performing a medical operation, the objective being to preclude injury in an industrial environment or infection in a medical environment.

8. The softness of the soft sealing pads adds to the comfort of wear, the tightness of wear, and the anti-slip effect of the eyeglasses so that the eyeglasses can be worn for a long time without causing discomfort or becoming a burden.

9. The soft sealing pads are coupled to the first lens in a detachable manner and therefore can be removed when no longer needed. Removal of the soft sealing pads helps increase ventilation in the eyeglasses while the eyeglasses are being worn, and this in turn prevents the eyeglasses from being fogged up with hot air, and thus becoming blurred, when the eyeglasses are worn for an extended period of time or under a high temperature.

### BRIEF DESCRIPTION OF THE SEVERAL VIEWS OF THE DRAWINGS

FIG. 1 is an exploded perspective view of an embodiment of the present invention.

FIG. 2 is an assembled perspective view of the embodiment in FIG. 1.

FIG. 3 is an enlarged view of the first pivotal connection portion and the second pivotal connection portion of the embodiment in FIG. 1.

FIG. 4 is an enlarged view of the first pivotal connection portion and the second pivotal connection portion of the embodiment in FIG. 1 as is viewed from a different viewing angle from that of FIG. 3.

FIG. 5 is an enlarged view of portion V in FIG. 2.

FIG. 6 is a sectional view showing the pivot shafts of the embodiment in FIG. 1 engaged in the pivot holes.

FIG. 7 is an assembled sectional view of the first pivotal connection portion and the second pivotal connection portion of the embodiment in FIG. 1.

FIG. 8 is an enlarged view of portion VIII in FIG. 7.

FIG. 9 shows how an engaging corner of the embodiment in FIG. 1 is engaged in the first engaging groove such that the second lens is flipped to one of various angular positions.

FIG. 10 is an enlarged view of portion X in FIG. 9.

FIG. 11 shows how an engaging corner of the embodiment in FIG. 1 is engaged in the second engaging groove such that the second lens is flipped to one of various angular positions.

FIG. 12 is an enlarged view of portion XII in FIG. 11.

FIG. 13 shows that the pivot shaft of the second pivotal connection portion of the embodiment in FIG. 1 that does not have the engaging end is inserted into the corresponding pivot hole first.

FIG. 14 shows how a user puts on the embodiment in FIG. 1 after putting on a pair of ordinary eyeglasses that the user wears in the first place.

FIG. 15 is similar to FIG. 14 except that the user has put on the embodiment in FIG. 1.

FIG. 16 is similar to FIG. 15 except that the second lens has been flipped open.

### DETAILED DESCRIPTION OF THE INVENTION

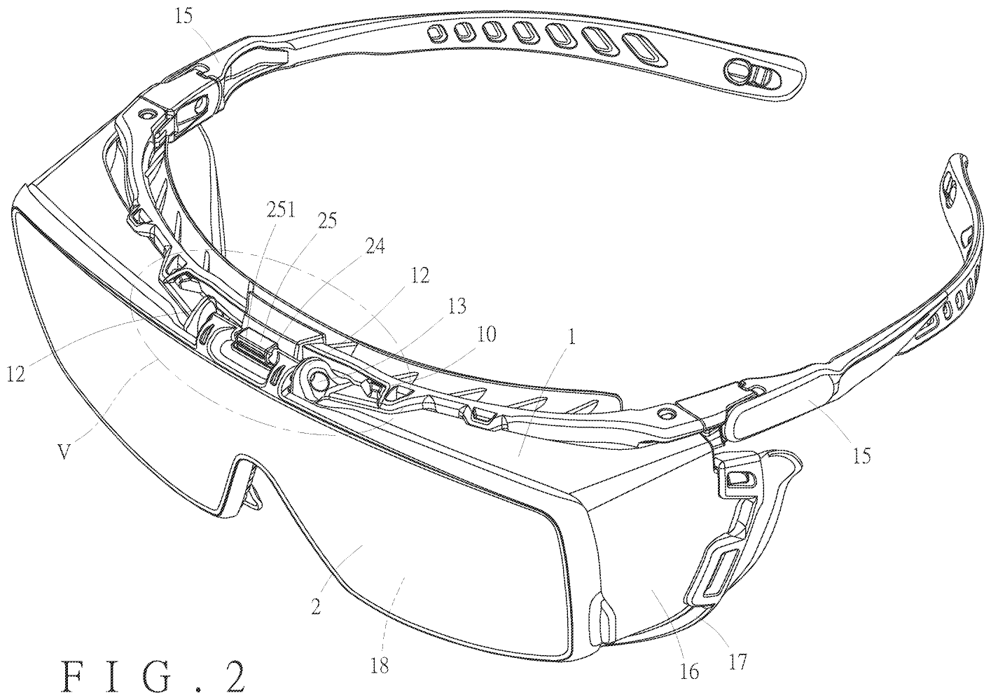

As used herein in connection with the embodiment described below, directional terms such as left, right, front, rear, upper, and lower make reference to the orientations of the eyeglasses in FIG. 2. Those directional terms are used only to facilitate description of the embodiment and are not intended to limit the spatial aspects of the present invention.

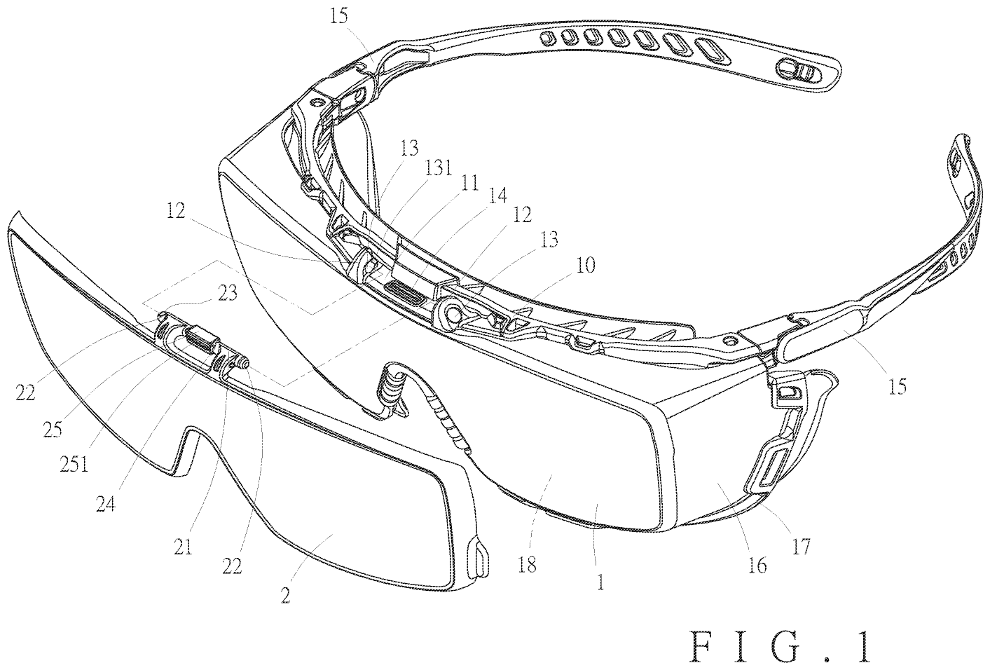

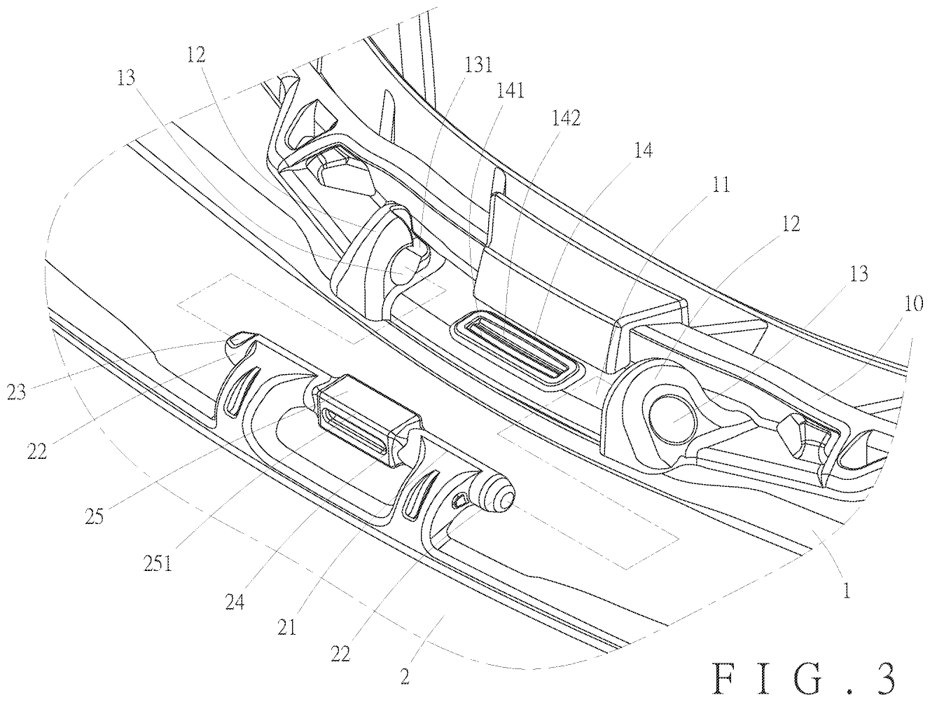

Referring to FIG. 1, FIG. 2, and FIG. 3, one embodiment of the present invention includes a first lens 1 and a second lens 2.

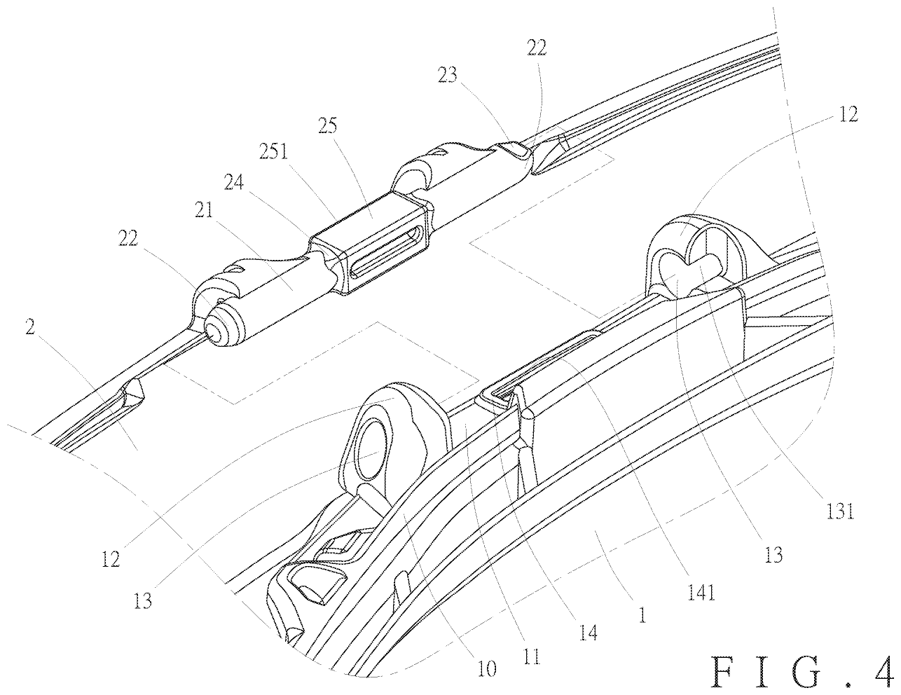

The first lens 1 has an eyeglass frame portion 10, and the eyeglass frame portion 10 has a middle portion provided with a first pivotal connection portion 11. The first pivotal connection portion 11 has two lateral sides each provided with a pivot block 12. The two pivot blocks 12 face each other and are each formed with a pivot hole 13. The two pivot holes 13 face each other. One of the pivot blocks 12 is provided with a notch 131 that is adjacent to and in communication with the corresponding pivot hole 13 (see FIG. 4). An engaging portion 14 is provided between the two pivot blocks 12, and the engaging portion 14 is provided therein with a first engaging groove 141 and a second engaging groove 142 that are adjacent to each other and in a front-and-rear relationship. The first lens 1 has two ends each pivotally connected with a temple 15. The two lateral sides (i.e., the left and right sides) of the first lens 1 are each extended with a transparent lateral window portion 16, and each lateral window portion 16 is detachably coupled with a soft sealing pad 17 along a lateral side and a bottom portion of the lateral window portion 16. The first lens 1 may be a frameless lens or a lens mounted in an eyeglass frame; the present invention has no limitation in this regard. The inner side of the first lens 1 defines a relatively large accommodating space 18 for accommodating a pair of ordinary eyeglasses that the user wears in the first place, so the user will not have problem wearing the eyeglasses in FIG. 2 together with, or putting on the eyeglasses in FIG. 2 while wearing, a pair of ordinary eyeglasses. Rather, the user will be able to put on the eyeglasses in FIG. 2 conveniently and wear them along with a pair of ordinary eyeglasses during work or other activities.

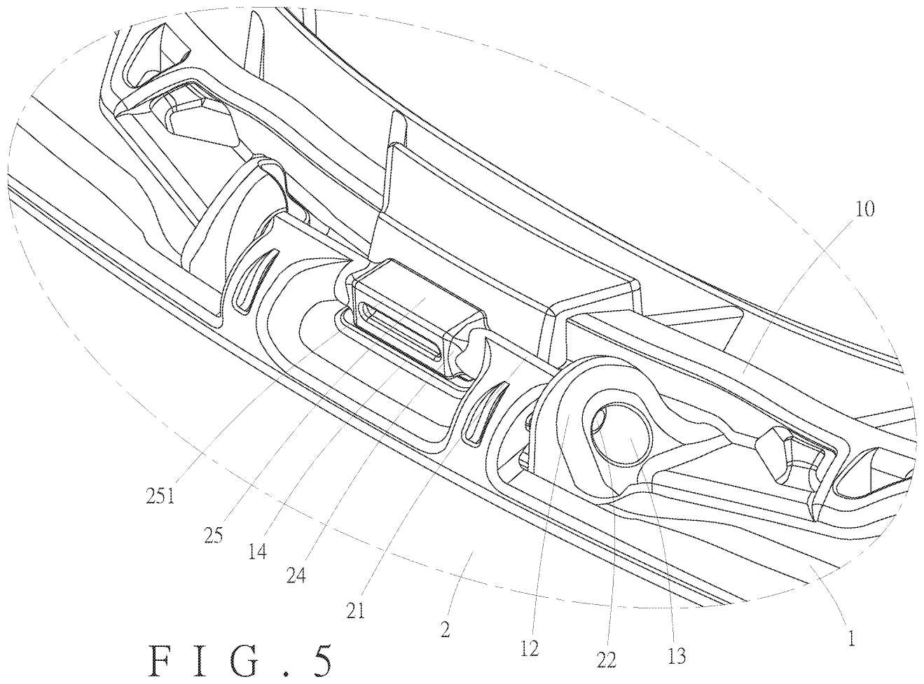

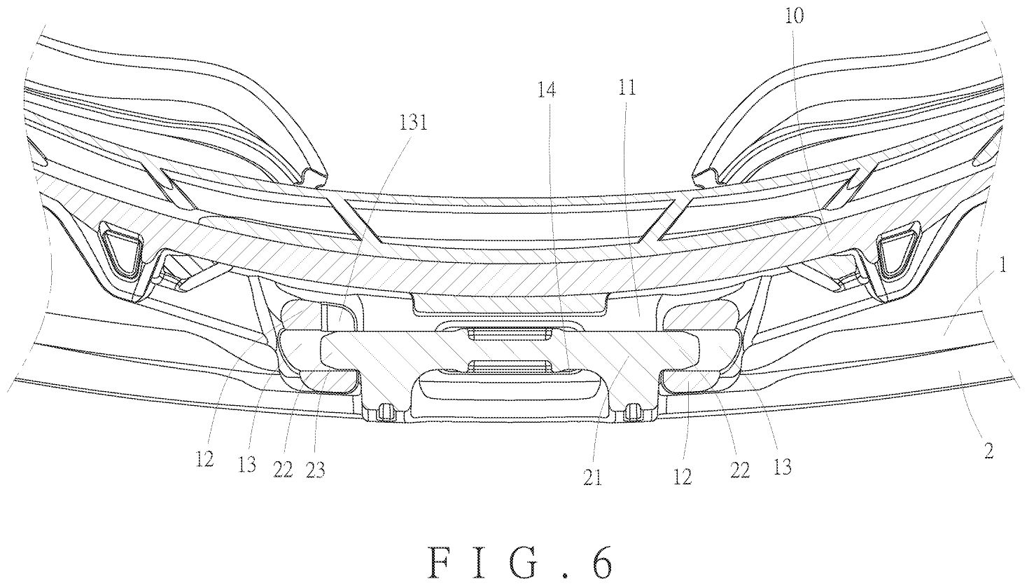

The second lens 2 has a middle portion provided with a second pivotal connection portion 21. The second pivotal connection portion 21 is pivotally connected to the first pivotal connection portion 11 (see FIG. 4 and FIG. 5) so that the second lens 2 can be flipped open with respect to the first lens 1. The second pivotal connection portion 21 has two lateral sides each provided with a pivot shaft 22 corresponding to one of the two pivot holes 13. Each of the two pivot shafts 22 is engaged in the corresponding one of the two pivot holes 13 (see FIG. 6). One of the pivot shafts 22 has an end portion corresponding to the notch 131 and cut flat on two opposite sides to form an engaging end 23. The thickness of the engaging end 23 is smaller than the size of the opening of the notch 131 so that the engaging end 23 of this particular pivot shaft 22 can be passed through the notch 131 and engaged in the corresponding pivot hole 13. The second pivotal connection portion 21 is further provided with an engaging block 24 between the two pivot shafts 22, and the engaging block 24 corresponds in position to the engaging portion 14. The engaging block 24 has a non-circular cross section. In this embodiment of the present invention, the engaging block 24 has a quadrilateral cross section and forms four contact surfaces 25 with respect to the engaging portion 14. In addition, the corner formed between each two adjacent contact surfaces 25 of the engaging block 24 is defined as an engaging corner 251, so the engaging block 24 in this embodiment forms four engaging corners 251. Each of the contact surfaces 25 can lie flat against the engaging portion 14, and each engaging corner 251 can be brought into engagement in the first engaging groove 141 or the second engaging groove 142, such that a plurality of angular positions at which the second lens 2 can be secured with respect to the first lens 1 are defined. A user may choose to flip the second lens 2 open at any of those angular positions. The first lens 1, the first pivotal connection portion 11, the second lens 2, and the second pivotal connection portion 21 are all made of plastic, are put together by engagement between corresponding structures, and therefore need not be held together by metal screws or elastic elements. This makes it possible to achieve a lightweight design in which the assembled eyeglasses weigh less than eyeglasses using metal screws or elastic elements. More importantly, electrical hazards associated with the use of metal screws or elastic elements are also eliminated to reduce occupational safety accidents attributable to the conduction of electricity, thereby ensuring the highest safety of use. The second lens 2 may be a protective lens for use in a medical environment, an eye-protecting lens for use in an industrial environment, a sun-blocking lens like those of sunglasses, a lens for vision correction (e.g., for correcting nearsightedness), or a sports lens for use in a sports activity.

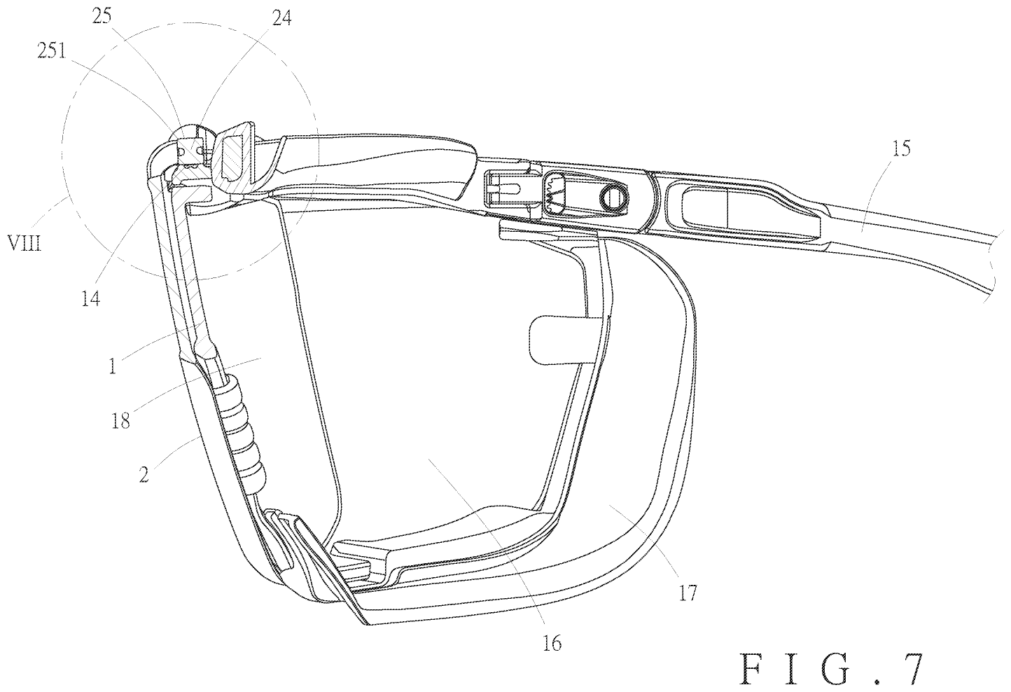

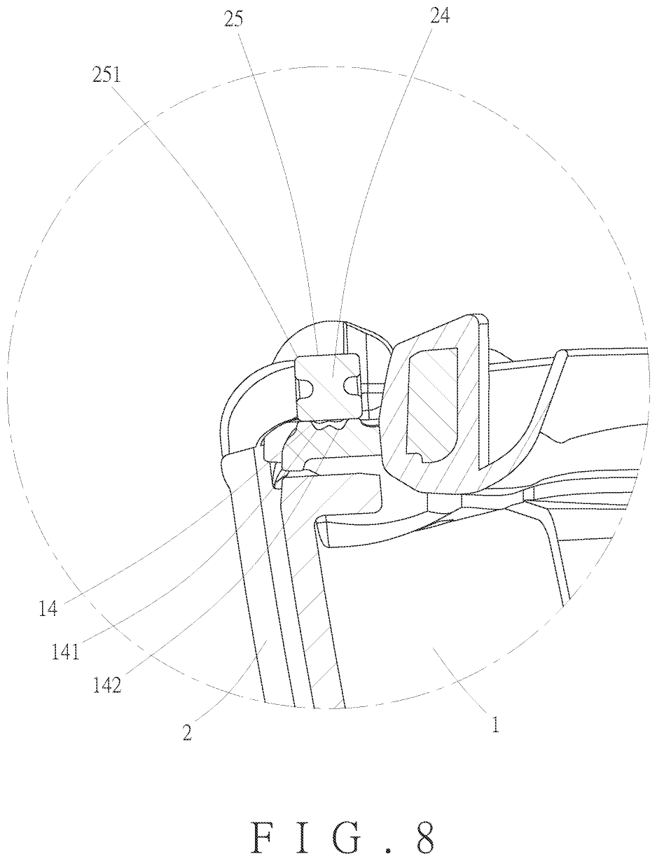

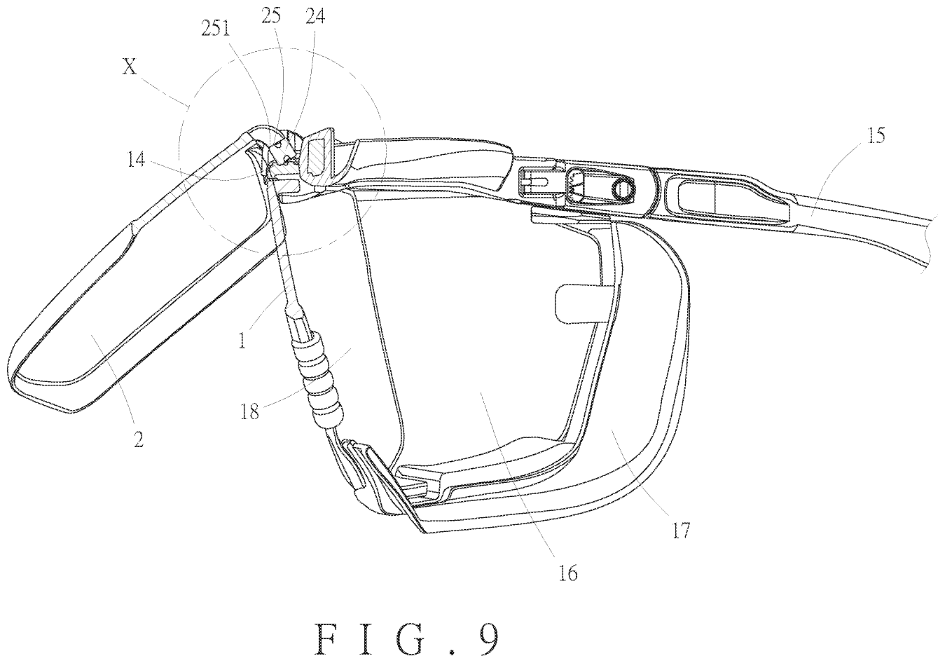

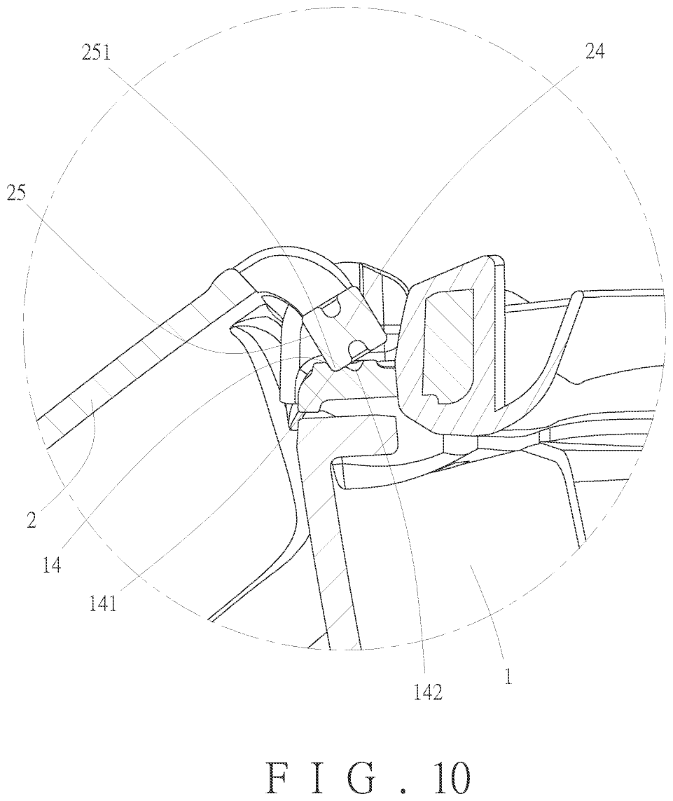

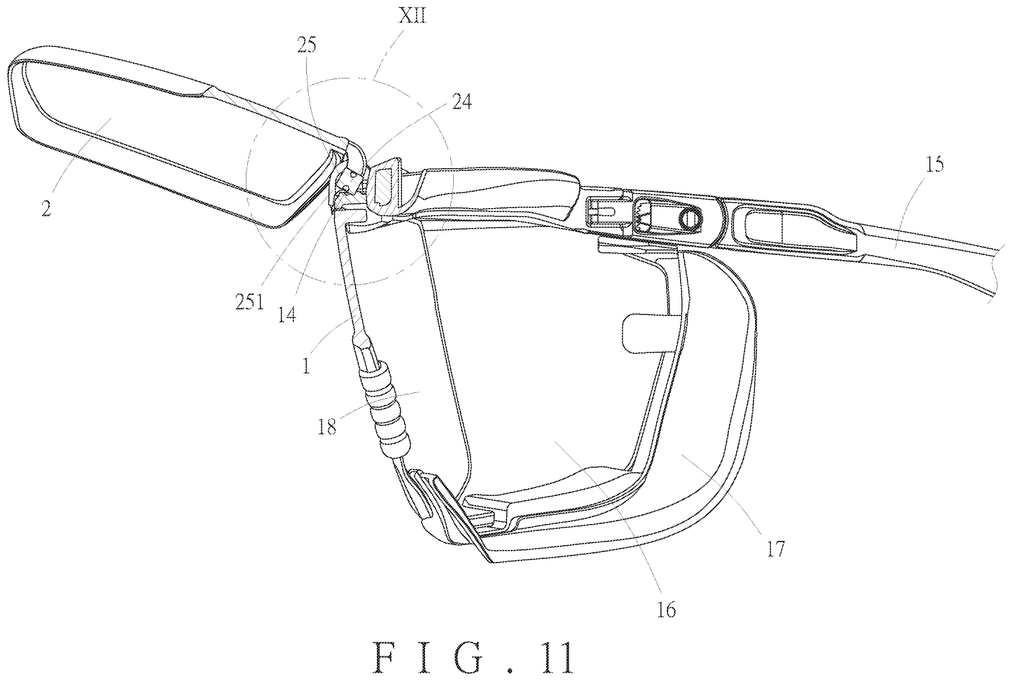

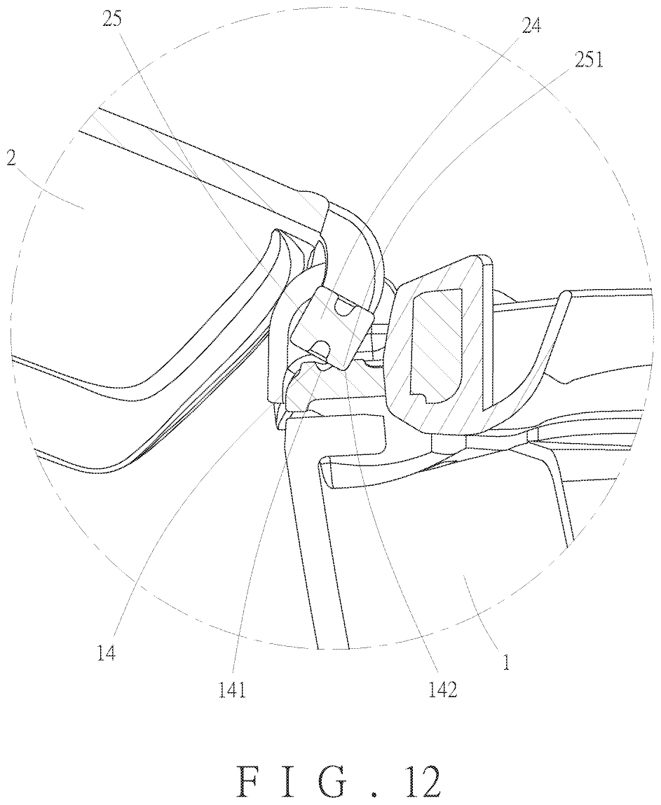

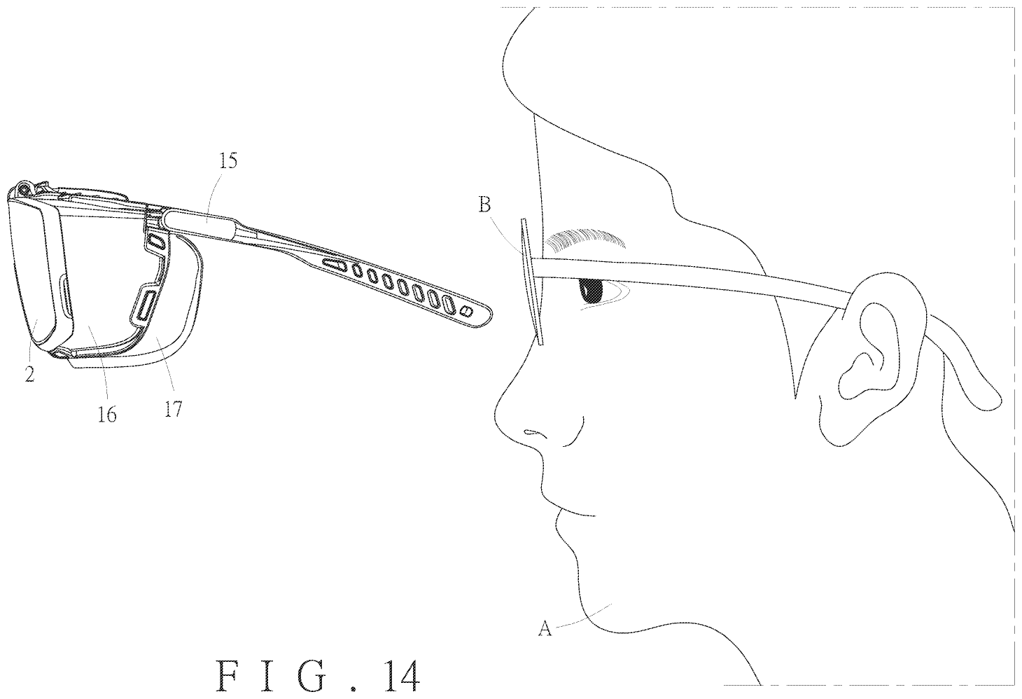

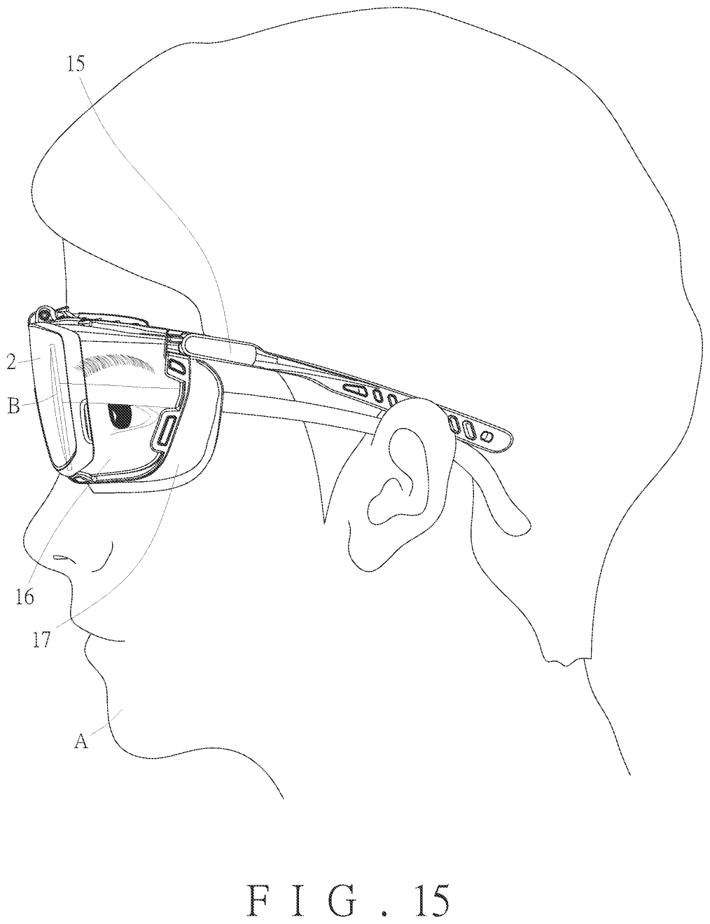

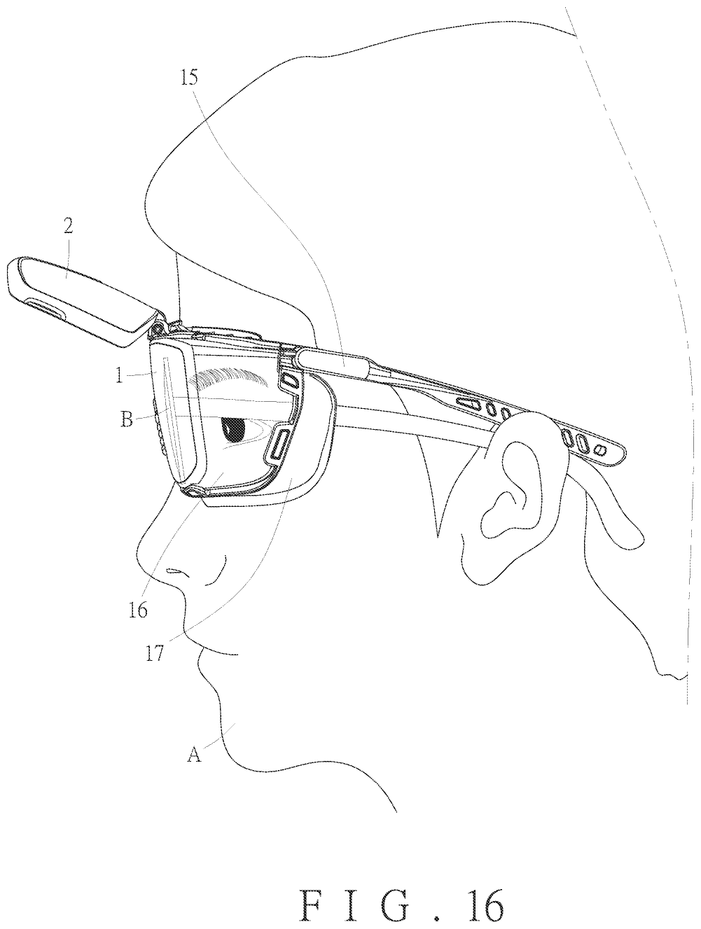

To flip the second lens 2 open while wearing the eyeglasses in FIG. 2 during work or other activities, referring to FIG. 1, FIG. 7, and FIG. 8, the second lens 2 is rotated with respect to the first lens 1 such that the two pivot shafts 22 of the second pivotal connection portion 21 are each pivoted in the corresponding one of the two pivot holes 13 of the first pivotal connection portion 11, the objective being to put one of the contact surfaces 25 flat against the engaging portion 14, or bring one of the engaging corners 251 of the periphery of the engaging block 24 into engagement in the first engaging groove 141 (see FIG. 9 and FIG. 10) or the second engaging groove 142 (see FIG. 11 and FIG. 12). A positioning effect will be produced when any of the contact surfaces 25 lies flat on the engaging portion 14 or when any of the engaging corners 251 is engaged in the first engaging groove 141 or the second engaging groove 142. As the inner side of the first lens 1 defines the relatively large accommodating space 18, a pair of ordinary eyeglasses B that the user A wears in the first place can be accommodated in the accommodating space 18 (see FIG. 14 and FIG. 15). Furthermore, the second lens 2 can be flipped open with respect to the first lens 1 (see FIG. 16) to meet different user needs. More specifically, the second lens 2 can be rotated in stages to, and positioned at any of, a plurality of flip-open angles with respect to the first lens 1 according to the vision requirements of different work or activities, and the user may choose whichever flip-open angle desired.

Referring to FIG. 1, when it is necessary to replace the second lens 2 with a different lens to suit different work or activities, the replacement for the second lens 2 may be chosen from a protective lens for use in a medical environment, an eye-protecting lens for use in an industrial environment, a sun-blocking lens like those of sunglasses, a lens for vision correction (e.g., for correcting nearsightedness), and a sports lens for use in a sports activity. To remove the second lens 2, referring to FIG. 4 and FIG. 5, the user rotates the second lens 2 with respect to the first lens 1 such that the two pivot shafts 22 of the second pivotal connection portion 21 are each pivoted in the corresponding one of the two pivot holes 13 of the first pivotal connection portion 11. When the engaging end 23 of that particular pivot shaft 22 corresponds to the notch 131 of the corresponding pivot hole 13, the user applies a little force to the engaging end 23 to pull it out of the corresponding pivot hole 13 through the notch 131. Once this pivot shaft 22 is separated from the corresponding pivot hole 13, the pivot shaft 22 at the opposite end of the second pivotal connection portion 21 can be separated from the other pivot hole 13 such that the second lens 2 is completely separated from the first lens 1 and ready to be replaced.

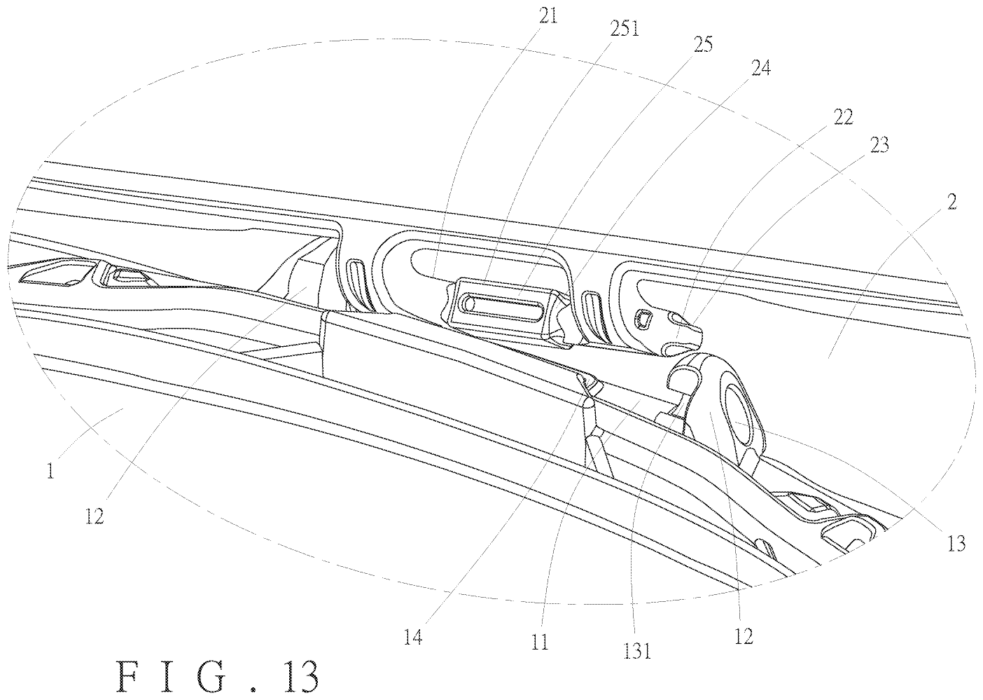

To secure another second lens 2 to the first lens 1, referring to FIG. 4, FIG. 5, and FIG. 13, the pivot shaft 22 of the second pivotal connection portion 21 that does not have the engaging end 23 is inserted into the corresponding pivot hole 13 first. Then, the second pivotal connection portion 21 is rotated with respect to the first pivotal connection portion 11 such that the pivot shaft 22 without the engaging end 23 is rotated in the corresponding pivot hole 13 while the pivot shaft 22 at the opposite end of the second pivotal connection portion 21, i.e., the pivot shaft 22 with the engaging end 23, is also rotated. Once the engaging end 23 corresponds to the notch 131, the user applies a little force to the engaging end 23 to push it into the notch 131, thereby allowing the two pivot shafts 22 to be rotated in the two pivot holes 13 of the two pivot blocks 12. The two pivot shafts 22 will be blocked by the walls of the two pivot holes 13 of the two pivot blocks 12 and therefore will not separate from the two pivot holes 13 easily, let alone hinder the work or activity the user is doing or cause danger as a result of such separation.

Referring to FIG. 6, FIG. 7, and FIG. 8, the first lens 1 can work with the soft sealing pads 17 to keep foreign objects from flying into the eyeglasses while the user is working, or to prevent a patient's body fluid, bacteria, or virus from reaching the user's eyes through a gap between the eyeglasses and the user's face while the user is performing a medical operation, the objective being to preclude injury in an industrial environment or infection in a medical environment. The eyeglasses, therefore, are particularly suitable for providing protection in a medical or industrial environment. The softness of the two soft sealing pads 17 also adds to the comfort of wear, the tightness of wear, and the anti-slip effect of the eyeglasses so that the eyeglasses can be worn for a long time without causing discomfort or becoming a burden. According to the present invention, not only can a protective lens for use in a medical environment, an eye-protecting lens for use in an industrial environment, a sun-blocking lens like those of sunglasses, a lens for vision correction (e.g., for correcting nearsightedness), or a sports lens for use in a sports activity be chosen as the second lens 2 to meet the vision requirements of different work or activities, but also the second lens 2 can be secured at multiple angular positions. The invention further provides ease of detachment and re-attachment, prevention against inadvertent separation, and convenience of use.

The above description of an embodiment of the present invention should be able to shed sufficient light on the operation, use, and intended effects of the invention. The disclosed embodiment, however, is only a preferred one of the invention and is not intended to be restrictive of the scope of the invention. Any simple equivalent change or modification based on the appended claims and the contents of this specification should be viewed as falling within the scope of the invention.

What is claimed is:

1. An engaging and securing structure of flip-up eyeglasses, comprising:
a first lens provided with a first pivotal connection portion, wherein the first pivotal connection portion has two lateral sides each provided with a pivot block, the two pivot blocks face each other and are each formed with a pivot hole, the two pivot holes face each other, an engaging portion is provided between the two pivot blocks, the engaging portion is provided therein with a first engaging groove and a second engaging groove, and the first engaging groove and the second engaging groove are adjacent to each other and in a front-and-rear relationship; and
a second lens provided with a second pivotal connection portion, wherein the second pivotal connection portion is pivotally connected to the first pivotal connection portion, the second pivotal connection portion has two lateral sides each provided with a pivot shaft, each said pivot shaft corresponds to and is engaged in one of the two pivot holes, the second pivotal connection portion is further provided with an engaging block between the two pivot shafts, the engaging block corresponds in position to the engaging portion, the engaging block has a non-circular cross section and forms a plurality of contact surfaces with respect to the engaging portion, each two adjacent said contact surfaces form a corner defined as an engaging corner, and any of the contact surfaces is selectable to lie flat on the engaging portion, or any of the engaging corners is selectable to be engaged in the first engaging groove or the second engaging groove, such that the second lens is able to be secured at a plurality of angular positions with respect to the first lens.

2. The engaging and securing structure of flip-up eyeglasses as claimed in claim 1, wherein the first lens has an eyeglass frame portion, the first pivotal connection portion is located at a middle portion of the eyeglass frame portion, and the second pivotal connection portion is located at a middle portion of the second lens.

3. The engaging and securing structure of flip-up eyeglasses as claimed in claim 1, wherein one of the pivot blocks is provided with a notch adjacent to and in communication with a corresponding one of the pivot holes, one of the pivot shafts has an end portion corresponding to the notch and cut flat on two opposite sides to form an engaging end, and the engaging end of the one of the pivot shafts is able to be passed through the notch and then engaged in the corresponding one of the pivot holes.

4. The engaging and securing structure of flip-up eyeglasses as claimed in claim 3, wherein the engaging end has a thickness smaller than a size of an opening of the notch.

5. The engaging and securing structure of flip-up eyeglasses as claimed in claim 1, wherein the engaging block has a quadrilateral cross section, the engaging block has four said contact surfaces with respect to the engaging portion, and the engaging block peripherally forms four said engaging corners corresponding to the first engaging groove or the second engaging groove.

6. The engaging and securing structure of flip-up eyeglasses as claimed in claim 1, wherein the first lens, the first pivotal connection portion, the second lens, and the second pivotal connection portion are made of plastic, are put together by engagement between corresponding structures, and therefore need not be held together by metal screws or elastic elements.

7. The engaging and securing structure of flip-up eyeglasses as claimed in claim 1, wherein the second lens is a protective lens for use in a medical environment, an eye-protecting lens for use in an industrial environment, a sun-blocking lens, a lens for vision correction, or a sports lens for use in a sports activity.

8. The engaging and securing structure of flip-up eyeglasses as claimed in claim 1, wherein the first lens has two ends each pivotally connected with a temple.

9. The engaging and securing structure of flip-up eyeglasses as claimed in claim 1, wherein the first lens has a left side and a right side each extended with a transparent lateral window portion.

10. The engaging and securing structure of flip-up eyeglasses as claimed in claim 9, wherein a soft sealing pad is detachably coupled to a lateral side and a bottom portion of each of the lateral window portions.
